(19) United States
(12) Patent Application Publication
(10) Pub. No.: US 2009/0241175 A1
(43) Pub. Date: Sep. 24, 2009

(54) METHODS AND SYSTEMS FOR USER AUTHENTICATION

(76) Inventors: David Trandal, Santa Barbara, CA (US); David Brahm, The Woodlands, TX (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/052,456

(22) Filed: Mar. 20, 2008

(51) Int. Cl. H04L 9/32; G06F 21/00

(52) U.S. Cl. 726/7

(57) ABSTRACT

The present invention relates to authentication, and in particular, to methods and systems for authenticating a user using electronic readable identifiers, networks, and data terminals. The user experience in accessing private accounts is enhanced while keeping such access secure from unauthorized individuals.

### CROSS REFERENCE TO RELATED APPLICATIONS

Not applicable.

### STATEMENT REGARDING FEDERALLY SPONSORED R&D

Not applicable.

### PARTIES OF JOINT RESEARCH AGREEMENT

Not applicable.

### REFERENCE TO SEQUENCE LISTING, TABLE, OR COMPUTER PROGRAM LISTING

Not applicable.

### FIELD OF THE INVENTION

The present invention relates to authentication, and in particular, to systems and methods for authenticating a user using electronic readable identifiers.

### BACKGROUND OF THE INVENTION

Consumers and corporate users expect a secure environment when accessing private information like billing or financial data over a shared data network (e.g., the Internet). However, these same consumers and corporate users don't want to be inconvenienced by creating and remembering strong passwords, user IDs, or to perform multiple authentication steps.

Electronically Readable Identifiers such as bar codes and data matrices are used to encode and decode information that can be optically scanned, for example by using mobile devices.

### SUMMARY OF THE INVENTION

Example embodiments simplify the user experience in accessing private accounts while keeping such access secure from unauthorized individuals.

### BRIEF DESCRIPTION OF THE DRAWINGS

Example embodiments will now be described with reference to the drawings summarized below. These drawings and the associated description are provided to illustrate example embodiments of the invention, and not to limit the scope of the invention.

FIG. 1 illustrates an example network operating environment for authentication systems.

FIG. 2 illustrates a first example operating environment/process for an online banking authorization.

FIG. 3 illustrates an example web page that a banking customer uses to initiate a simple and secure online banking transaction.

FIG. 4 illustrates a second example operating environment/process for an online banking authorization.

FIG. 5 illustrates a third example operating environment/process for an online banking authorization.

FIG. 6 illustrates a fourth example operating environment/process for an online banking authorization.

FIG. 7 illustrates a fifth example operating environment/process for an online banking authorization.

FIG. 8 illustrates a sixth example operating environment/process for an online banking authorization.

FIG. 9 illustrates a seventh example operating environment/process for an online banking authorization.

FIG. 10 illustrates an eighth example operating environment/process for an online banking authorization.

FIG. 11 illustrates a ninth example operating environment/process for an online banking authorization.

FIG. 12 illustrates a second example web page that a banking customer uses to initiate a simple and secure online banking transaction.

FIG. 13 illustrates a third example web page that a banking customer uses to securely login to their account.

FIG. 14 illustrates a tenth example operating environment/process for an online banking authorization.

### DETAILED DESCRIPTION OF THE PRESENT INVENTION

The methods and systems of the present invention both improve conventional access security while simplifying and enhancing the user access experience. In addition, these methods substantially improve security when accessing online accounts from a voice and data terminal outside of the home such as a Personal Computer in an Internet Café.

### GLOSSARY

Electronic Readable Identifiers (ERI) such as bar codes and data matrices are used to encode and decode information that can be optically scanned.] Embodiments described herein can be used with some or all of the currently known ERIs or any as yet undeveloped ERIs. This includes but is not limited to the following known electronically readable identifiers: Plessey, UPC-A, UPC-E, Codabar, Code 25 Non-interleaved 2 of 5, Code 25 Interleaved 2 of 5, Code 11, Code 39, Code 93, Code 128, Code 128A, Code 128B, Code 128C, CPC binary, DUN 14, EAN 2, EAN 5, EAN 8, EAN 13, GS1-128, GS1 DataBar, ITF-14, Latent Image Barcode, Pharmacode, PLANET, POSTNET, OneCode, MSI, PostBar, RM4SCC/KXX, Telepen, 3-DI, ArrayTag, Aztec Code, Small Aztec Code, bCODE, bullseye, Codablock, Code 1, Code 16K, Code 49, Color Code, CP Code, DataGlyphs, Datamatrix, Datastrip Code, Dot Code A, EZcode, High Capacity Color Barcode, HueCode, INTACTA.CODE, InterCode, MaxiCode, mCode, MiniCode, PDF417, Micro PDF417, PDMark, PaperDisk, Optar, QR Code, Semacode, SmartCode, Snowflake code, ShotCode, SuperCode, Trillcode, UltraCode, VeriCode, VSCode, and WaterCode.

Telephone Number Mapping (ENUM)—maps the telephone numbering system into the Internet addressing system.

International Mobile Equipment Identity (IMEI)—A unique identifier assigned to a given GSM or UMTS mobile phone. The IMEI number is used to identify the mobile device, and typically has no permanent or semi-permanent relation to the mobile phone subscriber.

Electronic Serial Number (ESN)—A number unique to a US-based mobile phone. The ESN number is used to identify the mobile device, and has no permanent or semi-permanent relation to the mobile phone subscriber.

Mobile Equipment Identifier (MEID) is a globally unique number identifying a CDMA mobile phone. MEIDs have replaced ESNs.

Web Site or Web is a term used throughout the following description. It is used to refer to a user-accessible network site that implements the basic World Wide Web standards for the coding and transmission of hypertext documents. These standards currently include HTML (the Hypertext Markup Language) and HTTP (the Hypertext Transfer Protocol). It should be understood that the term “site” is not intended to imply a single geographic location, as a Web or other network site can, for example, include multiple geographically distributed computer systems that are appropriately linked together. Furthermore, while the following descriptions relates to an embodiment utilizing the Internet and related protocols, other networks, such as networked interactive televisions, and other protocols may be used as well.

Further, while the following description refers to example networks and telephony standards and protocols, other standards and protocols can be used as well. The term phone Identifier (phone ID) can include a SIP address, a Skype address (or other peer-to-peer Internet telephony network address), a wireless phone number, an International number, an E. 164 phone number, an ENUM, an MEID, an IMEI, an ESN, or other yet undeveloped telephony address. While certain phone identifiers are referenced for purposes of illustration, other electronic addresses or locators can be used as well.

In addition, while references may be made to electronic scanners, e.g., the use of a mobile phone as a scanner, other electronic scanners and/or image capture devices can be used as well including the ability to capture an image displayed on the user's mobile device. In addition, unless otherwise indicated, the functions described herein may be performed by executable code and instructions stored in computer readable medium and running on one or more processor-based systems. However, state machines, and/or hardwired electronic circuits can also be utilized. Further, with respect to the example processes described herein, not all the process states need to be reached, nor do the states have to be performed in the illustrated order. Further, certain process states that are illustrated as being serially performed can be performed in parallel.

Similarly, while certain examples may refer to a personal computer system or data device, other computer or electronic systems can be used as well, such as, without limitation, an interactive television, a network-enabled personal digital assistant (PDA), a network game console, a networked entertainment device, a smart phone (e.g., with an operating system and on which a user can install applications) and so on. While certain references are made to certain example system components or services, other components and services can be used as well and/or the example components can be combined into fewer components and/or divided into further components.

In addition, while certain user inputs or gestures are described as being provided via phone key presses, data entry via a keyboard, or by clicking a computer mouse or button, optionally, user inputs can be provided using other techniques, such as by voice or otherwise.

While some examples refer to certain example messaging protocols (e.g., SMS or MMS) for illustrative purposes, other messaging protocols can be used as well (e.g., instant messaging, email, SMTP, etc.).

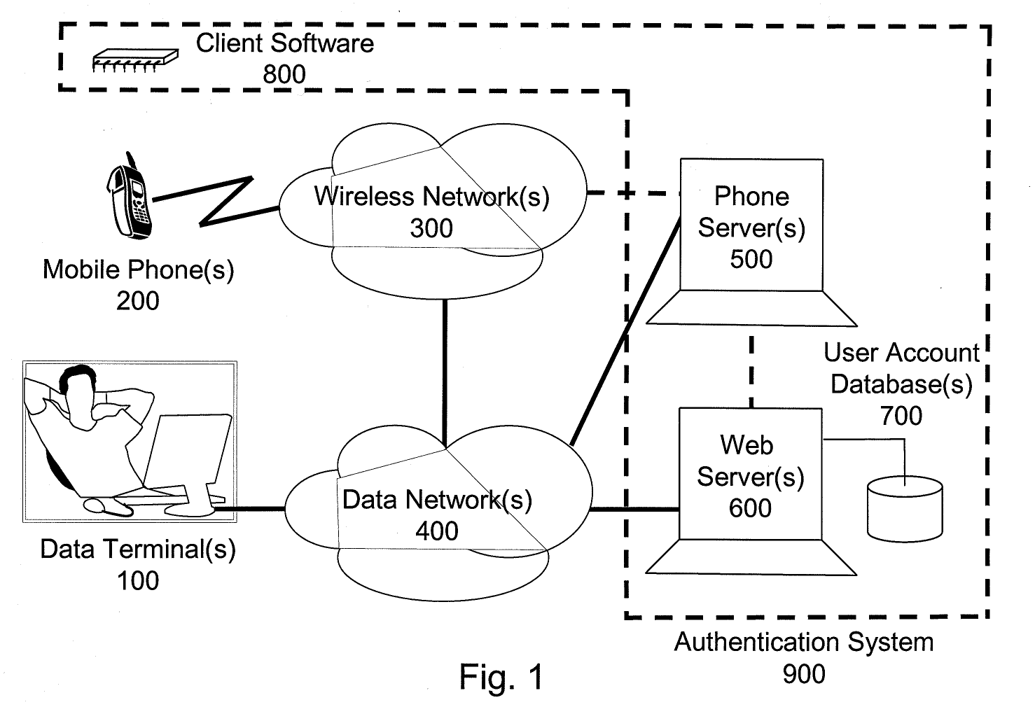

In addition, certain capabilities described herein make use of an authentication client application 800 hosted on a terminal (reference FIG. 1—e.g., a personal computer, a network personal digital assistant, a smart phone, or a mobile or wireless phone with an Internet connection, etc.) to assist in the user access to their private data. Optionally, a user can have multiple clients hosted on multiple computers or other hosts.

The functionality, operation, and implementation for an example authentication service will now be described in further detail.

FIG. 1 illustrates an example authentication system that can be used in accordance with the present invention. As illustrated, the authentication system includes a plurality of user mobile phones 200. The mobile phones 200 are connected to a wireless telephony and data network 300.

As further illustrated, the authentication system includes a plurality of computer terminals 100. The computer terminals 100 can be a personal computer having a monitor, keyboard, a disk drive, and a data communication interface. In addition, the computer terminal 100 can be an interactive television, a networked-enabled personal digital assistant (PDA) or the like. The computer terminals 100 are connected to a data network 400 (e.g., the Internet or a corporate LAN or WAN).

In an example embodiment, an authentication client 800 connects to and communicates with a phone server 500 either directly via the wireless network 300 or indirectly by linking the wireless network 300 with the data network 400. The authentication client application 800, executing on a subscriber's mobile phone 200 or other host, can interact with the optical scanning capabilities of the mobile phone to receive an image or the content of an image. Optionally, the client 800 can be used to transmit data to the authentication system 900 (e.g., by transmitting a message over the Internet). Optionally, the client 800 can make the user's online presence known to the authentication system 900 (e.g., by periodically transmitting a message over the Internet to the authentication system 900). Optionally, the client 800 can be used to receive and store in a computer readable medium a password (e.g., an alpha numeric password, a user biometric, etc.) from the user. For example, the user invokes the application (if the application is not already active) and enters a password (e.g., by key pressing or speaking a password). Optionally, the client 800 can be used to receive and store in a computer readable medium a copy of a password from a service provider 600 that the user has previously registered with. For example, the authentication system transmits a message over a wireless data connection to the client or via a Short Message Service (SMS). SMS is a wireless messaging service that enables the transmission of messages between mobile subscribers (and their phones) and external systems such as electronic mail services and authentication systems. Optionally, the client 800 can display status, success, and failure messages to the user. Optionally, the client 800 provides interfaces through which a user can enter data and/or respond to messages. Optionally, the client's authentication capabilities can be integrated into and can be a part of another application (e.g., a telecommunications client or a contact management client).

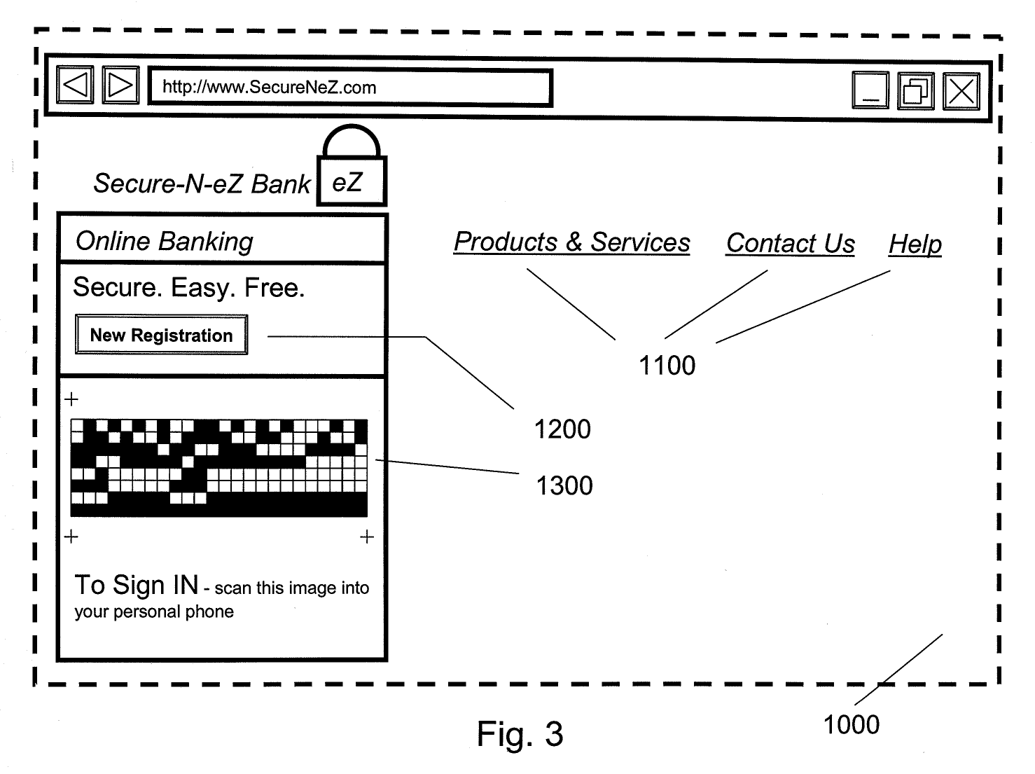

FIG. 3 illustrates an example authentication/registration user interface 1000 presented via a browser (or other interface application) to a user. The browser can be, by way of example executing on a computer terminal, such as a personal computer, a Wireless Application Protocol (WAP) or browser-enabled phone, a PDA or the like. The authentication/registration web page can optionally be accessed by supplying the appropriate URL to the browser, by selecting a link in response to a search query, or the like. The example user interface includes links for other information services 1100. The example user interface also includes a new registration button 1200 that links to another web page used to register a user. Lastly, the example user interface includes an electronic readable identifier 1300.

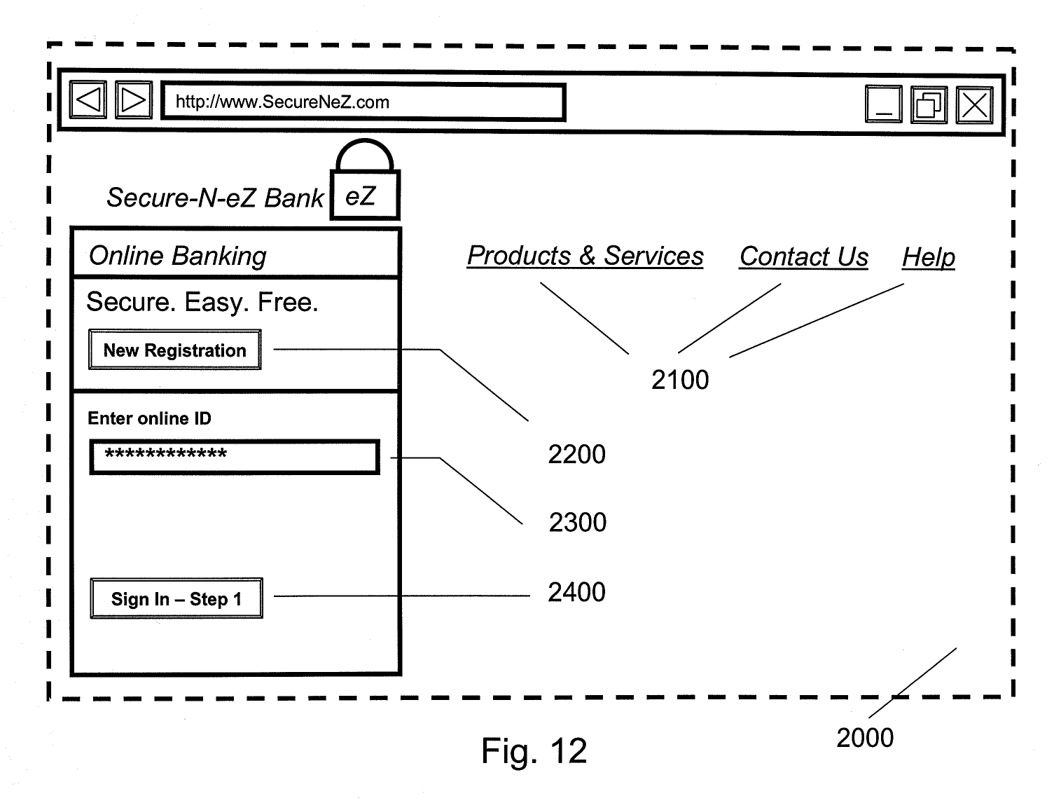

FIG. 12 illustrates a second example authentication/registration user interface 2000. In this example, the user is requested to enter their customer identifier. The example user interface includes links for other information services 2100. The example user interface also includes a new registration button 2200 that links to another web page used to register a user. The example user interface also includes a field 2300 for the user to enter a customer identifier. Lastly, the example user interface includes a submit button 2400 which can optionally be clicked on by a user to submit their customer identifier entered in field 2300. Different elements of a given user interface described herein can be combined with elements of other user interfaces.

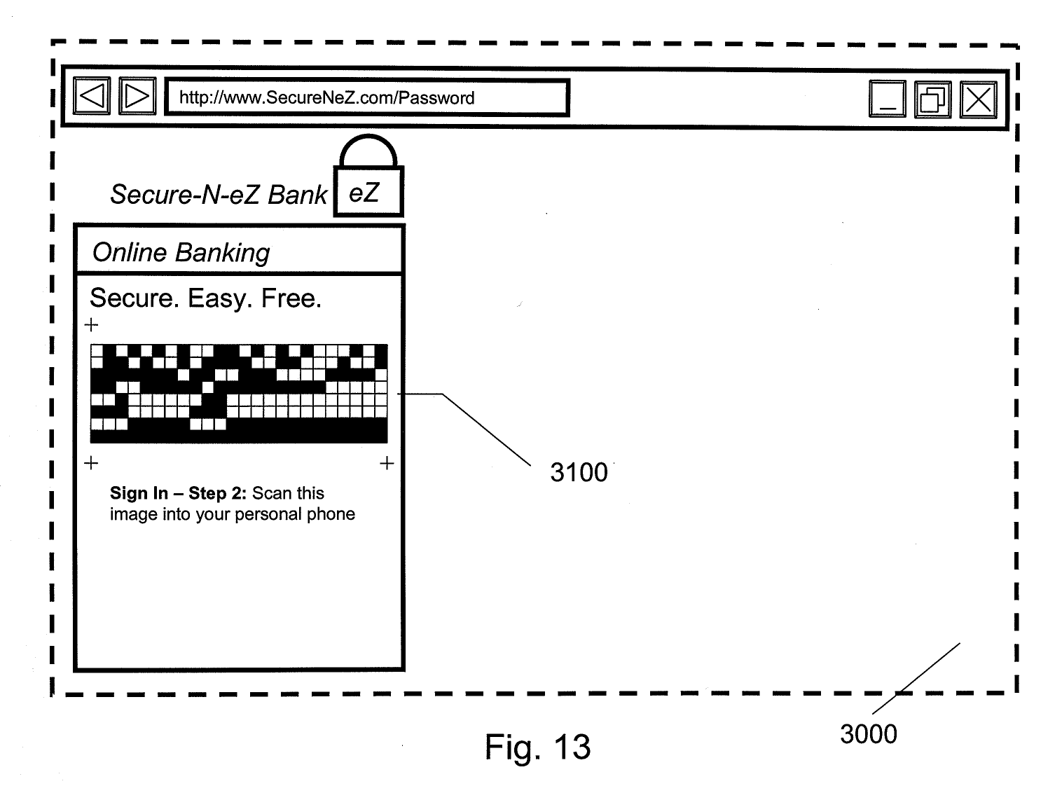

FIG. 13 illustrates an example authentication user interface 3000 presented via a browser to a user in response to submitting a customer identifier in FIG. 12. The example user interface includes an electronic readable identifier 3100.

In this example, the authentication servers 900 are optionally centralized at a given location, or distributed to a number of locations. The authentication system 900 can be a standalone system (e.g., an authentication system used by a number of service providers) or the authentication system is integrated into a service provider's internal systems (e.g., those systems employed to provide users online information access). Optionally, the authentication system is provided by a telecommunication carrier (e.g., Verizon) to service providers (e.g., banks). Optionally, there are no charges to use the authentication system. Optionally, the voice and/or data transactions between a user's mobile device and one or more authentication servers are not charged to the user but to the service provider or telecommunication carrier. Optionally, the authentication system is available to corporate employees of an enterprise and is not accessible by individuals outside of the enterprise. Optionally, the authentication system is connected to a data communication network 400 and a wireless network 300. The authentication system interconnects with the wireless network 300 using telecommunication interfaces (e.g., SS7) and via data communication networks using a secure router subsystem and an SMS server subsystem which optionally serves as a mail relay to transmit and receive SMS and MMS messages via a Short Message Service Center (e.g., an SMSC operated by a network carrier). These subsystems of the Authentication system are optionally interconnected via a Local Area Network (LAN), a Private Wide Area Private Network (WAN), and/or a Public Wide Area Network (e.g., Internet).

The authentication system in this example contains centralized databases and/or general-purpose storage areas, optionally including, but not limited to a customer/user database(s) 700. Optionally, the database(s) is not centralized and may be distributed geographically and/or over different systems. The database is optionally interconnected to the authentication system via a Local Area Network (LAN), a Private Wide Area Network (WAN), and/or a Public Wide Area Network (e.g., Internet).

Optionally, the authentication system includes a presence management subsystem. Presence managers optionally authenticate and track authentication client online presence and interact with a given authentication client (e.g., a client application hosted on a user's mobile phone) as information (e.g., passwords) is synchronized with the centralized databases to provide the user secure, reliable, and authentication and account updates.

Optionally, the authentication system includes access to other databases for additional levels of user verification. Optionally, the authentication system accesses name information from an SS7 Caller Name (CNAM) database and the hosting telecommunications carrier from the SS7 Local Number Portability database. The accessible information optionally includes phone identification information (e.g., from an SS7 LIDB (Line Information Data Base) or ENUM (Telephone Number Mapping) database). The chart below describes various example embodiments. The first column distinguishes each example by number. The second column summarizes the user interaction. The third column summarizes the corresponding data elements used for authentication. The fourth column summarizes for each example the resultant level of security. It should be understood that the herein examples list only certain variations of the present invention and are not to be limited to only these variations. Other example variations are possible, e.g., combing two or more variants from the examples listed below.

| | | Transmitted Data |
|---|---|---|
| | | Elements |
| | | Between Phone and |
| | User Interaction | Authentication System |
| 1 | User accesses web site | Service Provider ID |
| | User scans displayed ERI | Web Session ID |
| | | Phone ID |
| 2 | User accesses web site | ERI with embedded |
| | User scans displayed ERI | Service Provider ID & |
| | User transmits the scanned ERI | Web Session ID |
| | | Phone ID |
| 3 | User accesses web site | Service Provider ID |
| | User scans displayed ERI | Web Session ID |
| | | Encrypted password |
| | | previously stored in |
| | | phone |
| | | Phone ID |
| 4 | User accesses web site | Service Provider ID |
| | User scans displayed ERI | Web session ID |
| | | Biometric data |
| | | previously stored in |
| | | phone |
| | | Phone ID |
| 5 | User accesses web site | Service Provider ID |
| | User scans displayed ERI soon | Web Session ID |
| | thereafter to prevent time-out. | Phone ID |
| 6 | User accesses web site | Service Provider ID |
| | Users scans biometric data soon | Web Session ID |
| | thereafter to prevent time-out | Phone ID |
| | User scans displayed ERI | |
| 7 | User accesses web site | Service Provider ID |
| | User scans displayed ERI | Web Session ID |
| | User observes dynamic | Phone ID |
| | password sent to phone | |
| | User enters that password on | |
| | web form | |
| 8 | User accesses web site | Service Provider ID |
| | User scans displayed ERI | Web Session ID |
| | User observes dynamic | Phone ID |
| | password sent to phone | |
| | User enters that password on | |
| | phone | |
| 9 | User accesses web site | Service Provider ID |
| | User enters an identifier | Phone ID |
| | associated with his/her account | |
| | User scans displayed ERI | |
| 10 | User accesses web site | Service Provider ID |
| | User enters an identifier | Phone ID |
| | associated with his/her account | Password sent to |
| | User scans displayed ERI | Mobile Device |
| | User enters password | |
| | transmitted to phone | |

### EXAMPLE EMBODIMENT 1

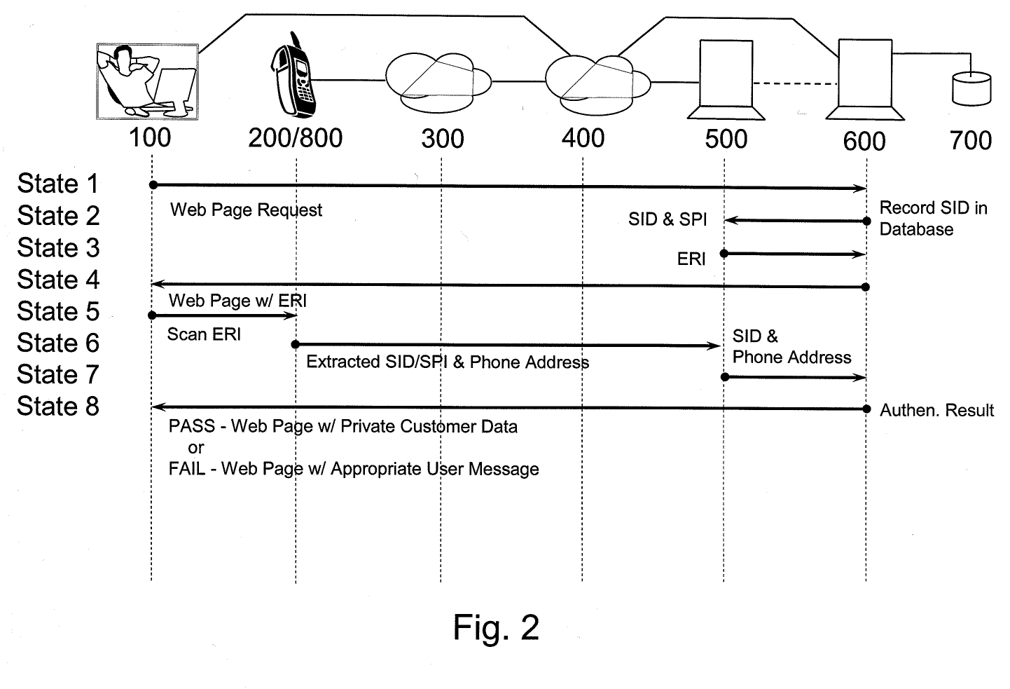

### See FIG. 2

FIG. 2 depicts a first example embodiment where a bank customer/user wants to access his/her online banking account.

Before accessing his/her account, it is presumed (in this example) that the user established and configured an online account by, for example, contacting a bank representative or by another example (see FIG. 3), creating an account in an online session 1000. It is further presumed that during the registration process the user communicates to the banking service provider a unique identifier for his/her mobile phone. In this example, this information could be his/her mobile phone number, the International Mobile Equipment Identifier (IMEI) of the mobile phone, and/or the Electronic Serial Number (ESN) of the mobile phone. The registration process creates an association between the user's mobile phone and the user's bank account.

In this example embodiments and others, if the user changes their phone number (e.g. by purchasing a new phone), they contact their banking service provider via the web or phone and re-register their new phone identifier.

State 1. The user accesses the bank's web site which hosts an online banking service. In this example, the user browses to the bank's web site using a personal computer 100 connected to data network 400. Optionally, any data networking capable device can be used by the user including for example, a mobile phone with data networking capabilities.

State 2. The bank's web hosting server 600 records the user request in the subscriber database 700 or any similar data store along with a unique identifier for this user's web browser session (called the web Session ID or SID). Given the bank's web site is hosting many simultaneous online banking sessions, the unique SID distinguishes this user's online access from others. In an analogous fashion, different application services running on web server 600 sharing access to the phone server 500 are distinguished by assigning a Service Provider ID (SPI) to each. The SPI uniquely identifies the service provider and/or provides a data or phone network location for authentication. Example SPIs optionally include but are not limited to the following: the data network address of the bank's authentication system, the phone number of a call processing system connected to the bank's authentication system, and a unique 10 digit operating company number which can be used by a software application within the handset to lookup a destination network address.

The bank's web hosting server 600 passes this information to the phone server 500 for additional processing.

State 3. The phone server 500 receives the passed information from the bank's web hosting server 600 and creates an ERI for this user. In this example embodiment, the ERI is a data matrix. The phone server 500 encodes the information in the data matrix including but not limited to a unique web Session Identifier (SID) and a Service Provider Identifier (SPI).

State 4. The bank's web hosting server 600 merges the ERI onto the web page image and presents the web page 1000 to the user (see FIG. 3).

State 5. The user scans the ERI 1300 displayed on the web page 1000. In this example, the customer uses his/her cell phone to perform the scanning (e.g., image capture) operation.

State 6. The scanned data matrix is decoded by one or more software programs 800 within the mobile device 200 interacting with the scanning subsystem of the mobile phone. The information extracted from the decoded data matrix is transmitted to the banking service provider phone server 500 using at least in part information included in the data matrix. In this example, the decoded information is transmitted to the banking service provider authentication server(s) 900 over a wireless data network.

In the same transmission or a subsequent transmission, the wireless phone ID of the mobile device is also transmitted to the phone server 500. Optionally, the wireless phone ID is the E.164 address. Optionally, the client application 800 hosted on the user's mobile phone 200 requests the user's Mobile Identification Number (MIN) from the telecommunication carrier providing wireless services to the user. The user's MIN is stored in the telecommunications carrier's Home Location Register (HLR). Optionally, the MIN is transmitted to the Authentication System 900. Alternatively, the authentication system 900 accesses the MIN by submitting a request using the user's phone ID using a separate and unique network connection (e.g., SS7) and the two MINs are compared. If the two MINs do not match, the user is denied access.

The wireless transmission of the decoded ERI information in this example is transmitted over the wireless network 300 using protocols including but not limited to a proprietary protocol or an open messaging protocol (e.g. Short Message Service, Multimedia Messaging Service, or SMTP).

State 7. The phone server 500 interfaces with the mobile phone 200 either directly through the wireless network 300 or (as is shown in this example) through the serial connection of the wireless network 300 trunked to the data network 400. The phone server 500 receives the user's mobile phone ID (or an equivalent phone identifier associated with the mobile phone) and the Web SID (and optionally other information) from the decoded data matrix which it passes to the bank's web hosting server 600.

State 8. The bank's web hosting server 600 looks up the SID in the previously stored table of active SIDs and compares the received mobile phone ID (or equivalent) with a list of user accounts in the database 700.

If a phone Identifier (ID) match is found a “Pass” indication is stored and the web server 600 grants the user access to his/her online account by changing the state of the user's web session (the web session identified by the SID) to logged in. The server 600 then opens the account and sends the selected user information to the user's data terminal 100.

If a phone ID match is not found, a “fail” indication is stored and the web server 600 rejects the login and optionally, presents a user access denied message on the user's terminal 100.

Optionally in State 8, a notification can be sent to the mobile phone 200 of the user. This notification can be a text message describing the successful or unsuccessful login attempt. In another example, the notification can trigger an application 800 on the mobile handset that provides a rich visual presentation of the successful or unsuccessful login. The notification can optionally include a phone number or web address that can be used by the user for additional assistance.

This example embodiment illustrates a technique for providing the user with simple and secure access to online content. With this embodiment the user is not required to remember or enter a customer ID and/or a password to access their online account.

### EXAMPLE EMBODIMENT 2

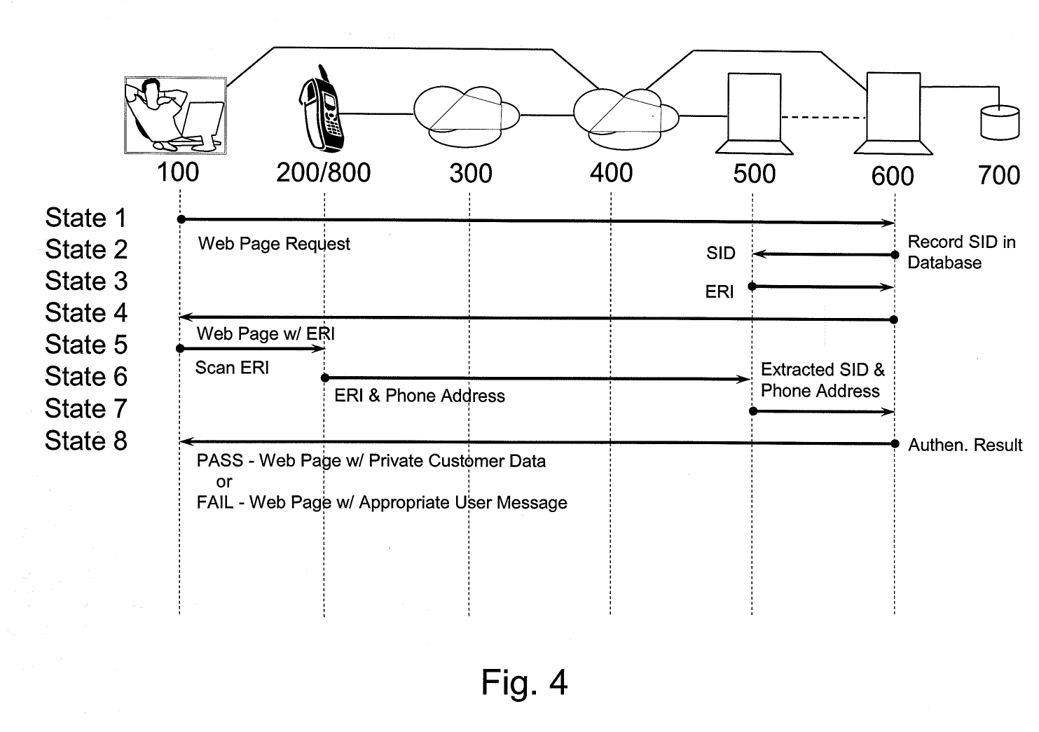

### See FIG. 4

FIG. 4 depicts a second example embodiment which is similar to the first except that the ERI feature extraction is performed in the phone server 500 rather than software 800 resident in the mobile phone 100. This obviates the need for special software to be loaded in the mobile phone 200.

In State 6, the scanned image of the ERI or data matrix in this example is transmitted directly to the phone server 500 where the SID is extracted by decoding the ERI. In this example embodiment, the user would need to explicitly specify the destination phone server 500 address when transmitting the scanned image.

### EXAMPLE EMBODIMENT 3

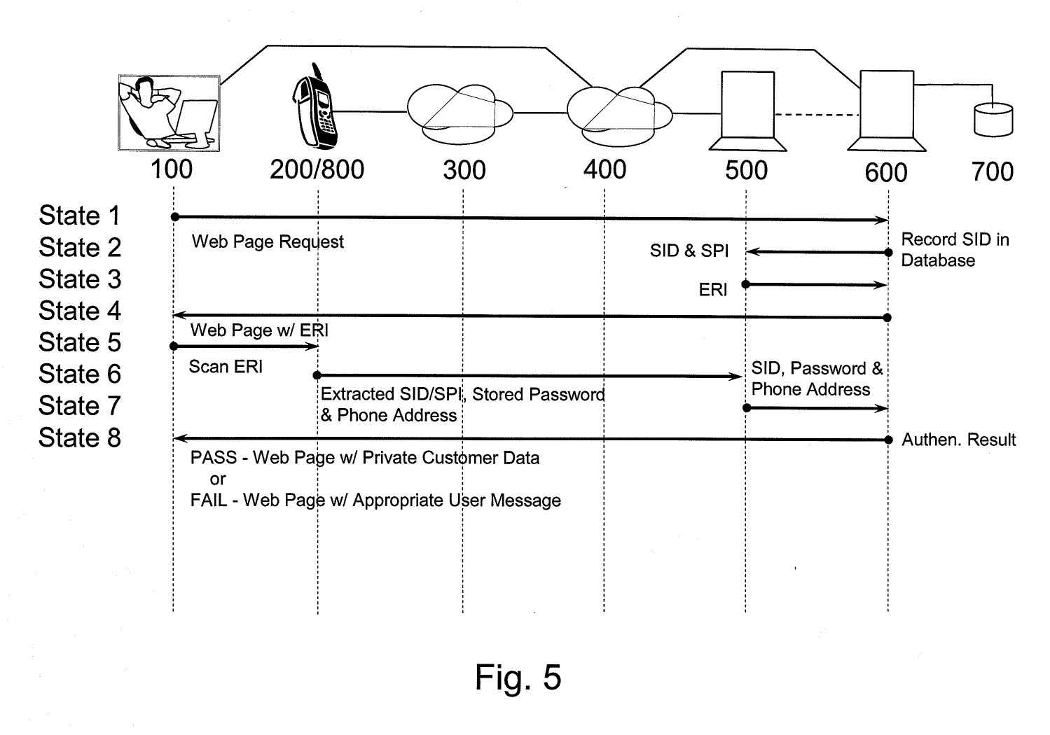

### See FIG. 5

FIG. 5 depicts a third example embodiment which is also a variant of the first with the noted exception that a copy of the user's password stored in the user database 700 is also recorded in the mobile phone 200. Optionally, the user's password is created by the service provider and assigned but never presented to the user. In this example, a random twelve hexadecimal digit number is created by the service provider's web hosting server 600 and transmitted (via SMS or SMTP) to the client software application 800 running on the user's mobile phone 200. The client software application 800 stores the user's password in computer readable medium in the phone 200. inaccessible to the user. Optionally, the user's password can be examined and/or modified by the user or the service provider. Optionally, the user's password is changed (for example—on each login, or more often or less often). During states 6-8, this password is passed by the software 800 in the mobile phone 200 through the phone server 500 to the web server 600 where it is used in conjunction with the SID and phone ID to lookup and confirms the user's account information in the user database 700. This enhancement improves the level of security of the service. Security can be further strengthened by encrypting the password copy stored in the phone 200 and transmitted to the phone server 500.

### EXAMPLE EMBODIMENT 4

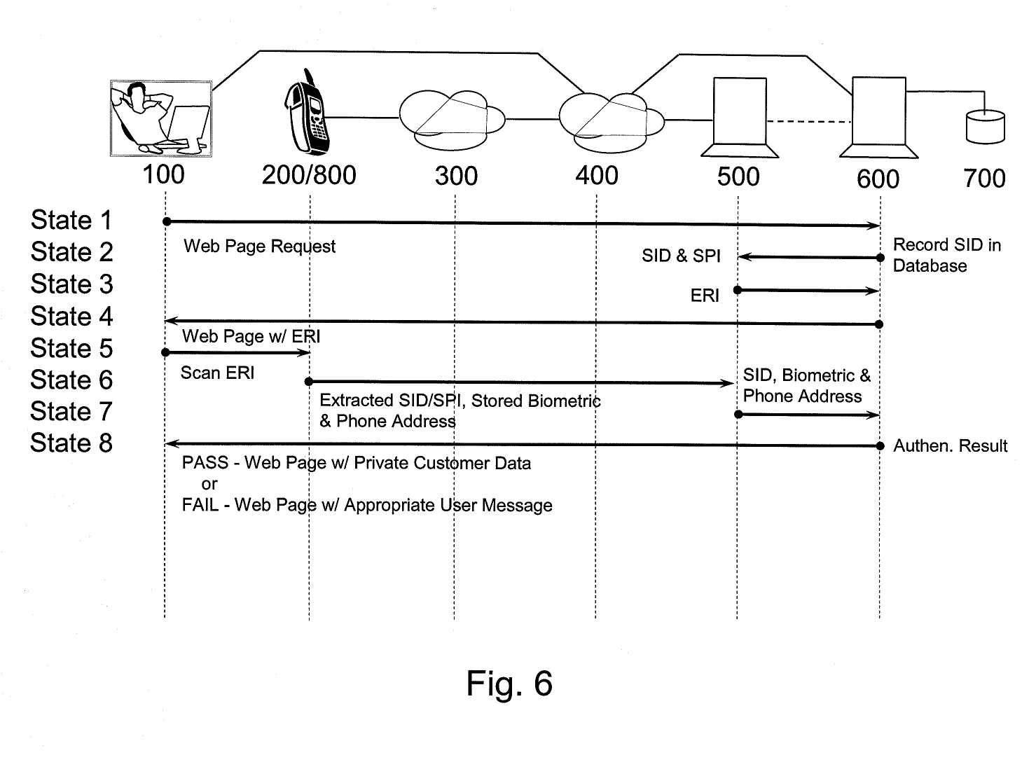

### See FIG. 6

FIG. 6 depicts a fourth example embodiment which is a variant of the third with the noted exception that the copy of the user's “password” stored in the user database 700 was created using biometric information unique to the user. In this example, the biometric data is stored in the user database 700 and synchronized with the stored copy in the mobile phone 200 by the client application 800. The biometric can be an image of the user's finger print, an image of the user's eye, a voice print of the user's spoken password, etc. (e.g., captured using phone camera, fingerprint reader, voice recording, etc.)

### EXAMPLE EMBODIMENT 5

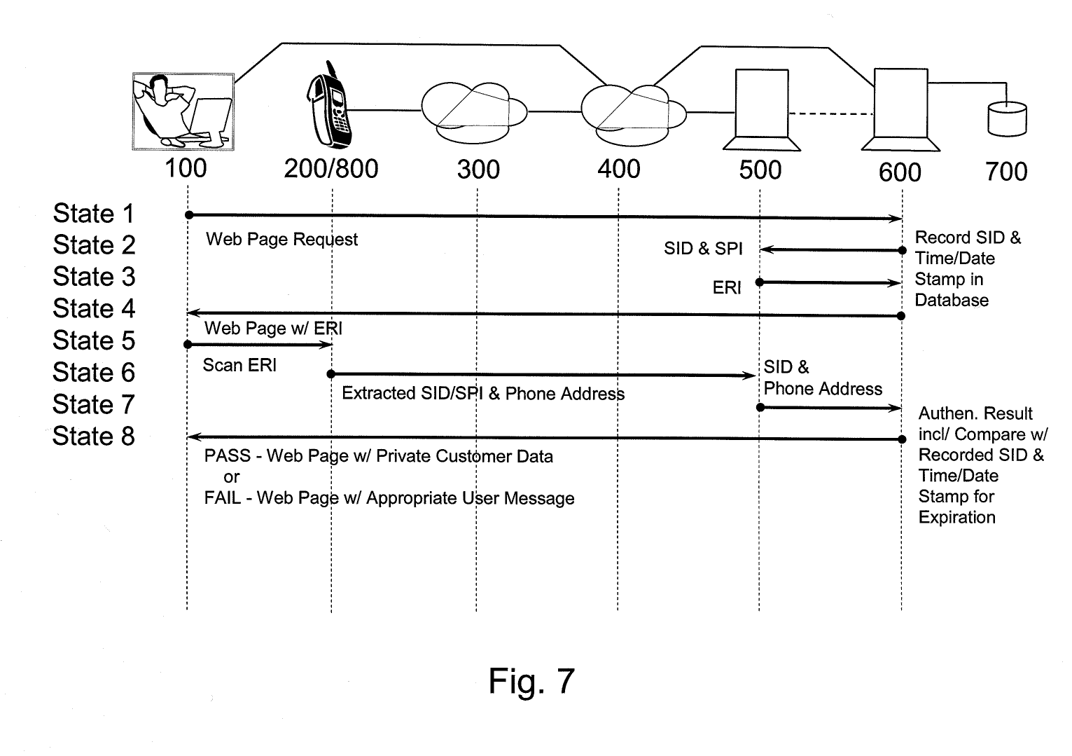

### See FIG. 7

FIG. 7 depicts a fifth example embodiment which is again a variant of the first with the added enhancement being that a date/time stamp is recorded with the SID logged in the user data base 700 during state 2. Then during state 8, the web server 600 contrasts the recorded date/time stamp with the time of receipt of the returned SID and phone ID from the phone server 500 to assure that a time-out threshold has not been exceeded. Additionally, when the web server 600 detects that the time-out threshold has been exceeded (independent of notification from the phone server 500), the web server 600 notifies the user by updated the web page on the data terminal 100.

### EXAMPLE EMBODIMENT 6

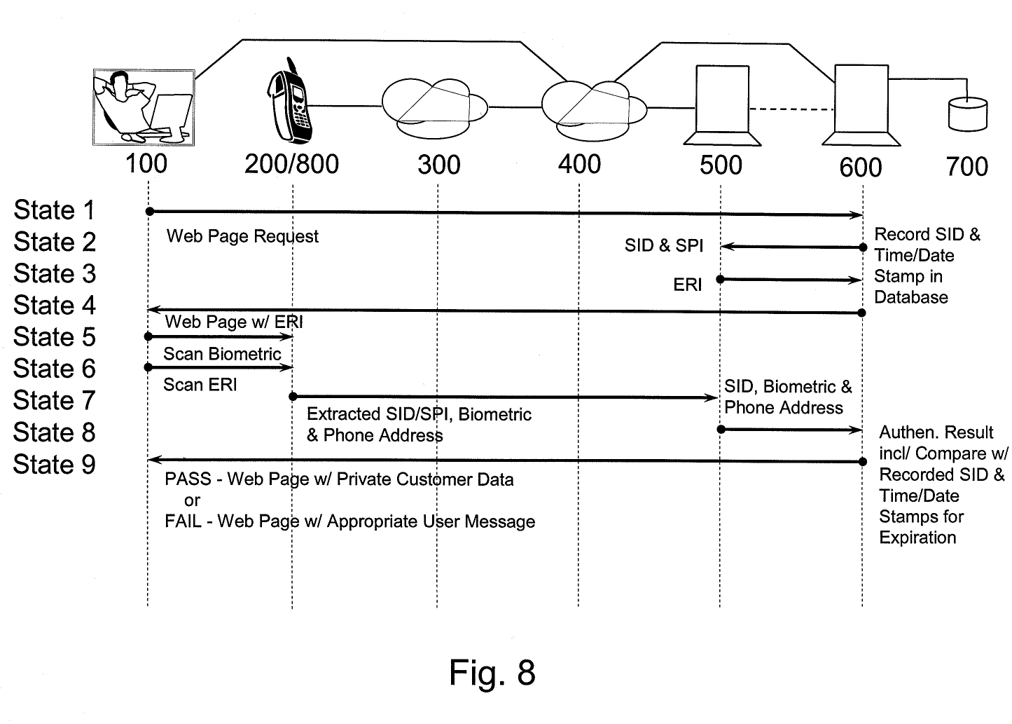

### See FIG. 8

FIG. 8 depicts a sixth example embodiment which combines several of the previous variants to embodiment 1 and adds a “fresh” biometric scan as a more secure alternative to a previously stored password. The user performs an additional transaction to scan the biometric information into the mobile phone 200 after receipt of the requested web page with embedded ERI. In this example, software 800 in the mobile phone 200 then extracts features of the biometric information (e.g., key identification features) along with the current date and time which is passed through the phone server 500 to the web server 600 for comparison with the user's account information.

### EXAMPLE EMBODIMENT 7

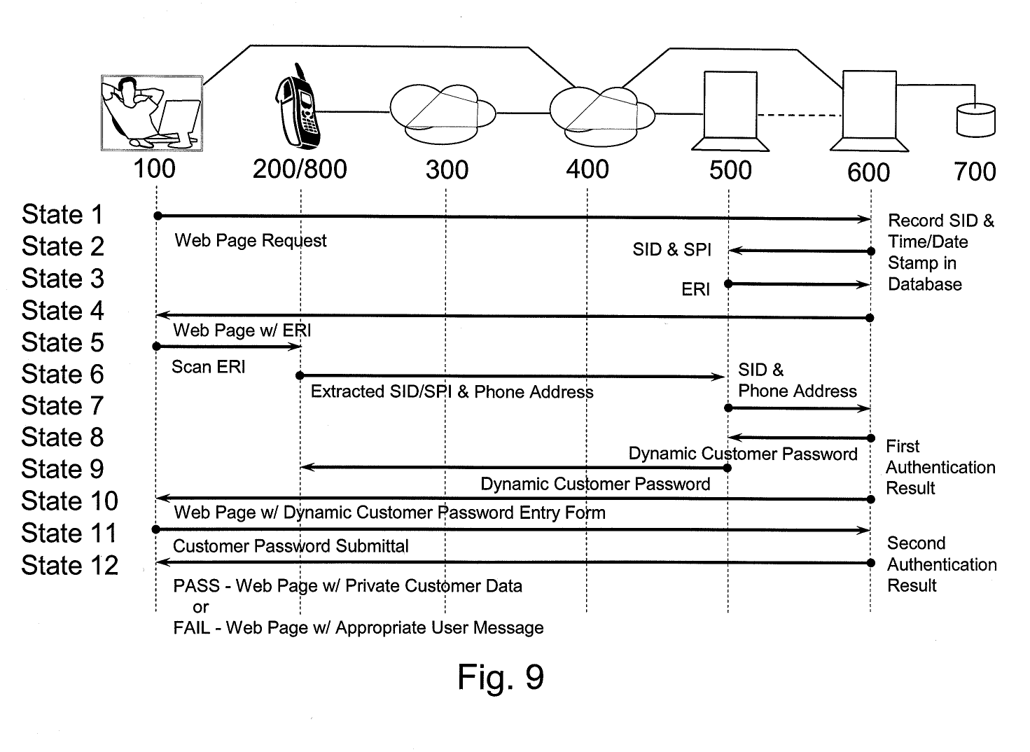

### See FIG. 9

FIG. 9 depicts a seventh example embodiment which, like the previous embodiment 6, also includes an additional user transaction to improve security. States 1-7 correspond to those detailed in the first example embodiment above.

During states 8-10, after confirming that the online user is registered in the user database 700, the web server 600 then sends a dynamically generated temporary password to the user's phone 200 and then sends a new password entry web form to the user's data terminal 100.

State 8. The web server 600 dynamically creates a password and transmits that password to the phone server 500.

State 9. The phone server 500 transmits the password to the user's mobile phone 200, for example by sending a message or by speaking the password during a voice call.

State 10. The web server 600 causes a web form to be displayed on the user's data terminal 100.

State 11. The user visually or audibly observes the received password displayed or played out on their phone 200, manually enters the information into the web form, and then submits the filled in form for review by the web server 600.

State 12. The web server 600 compares the password entered by the user with the dynamic password previously sent. If that they match, the web server then allows the user to access the authorized user information.

### EXAMPLE EMBODIMENT 8

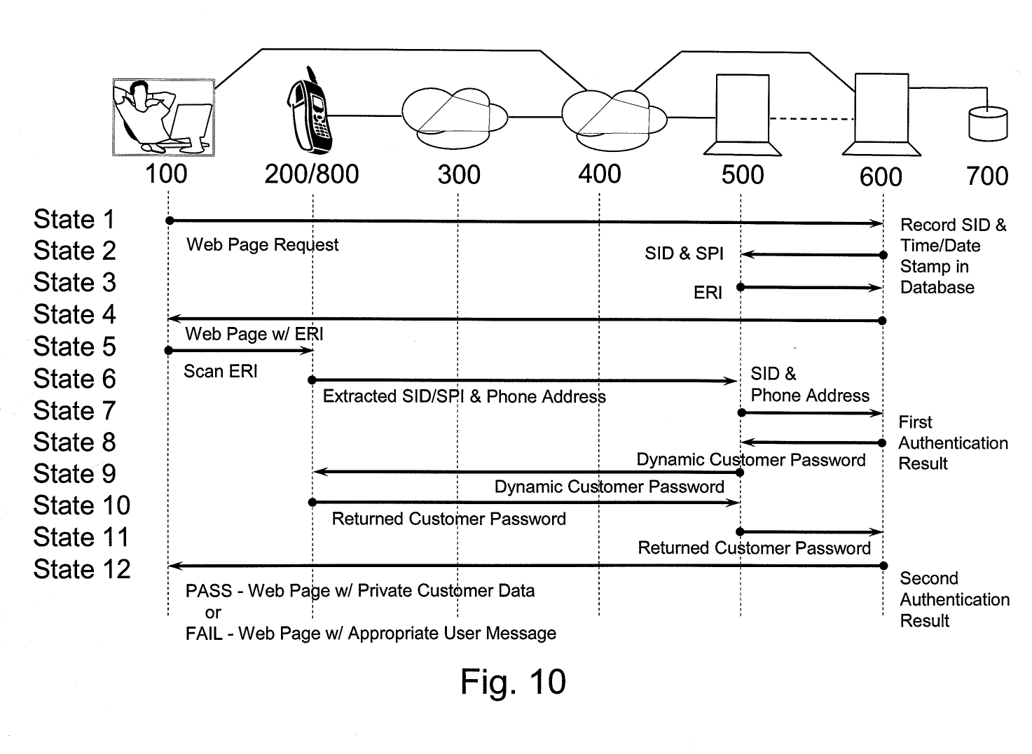

### See FIG. 10

FIG. 10 depicts an eighth example embodiment which is a variation of embodiment 7, where the received password displayed/played out on the user's phone 200 is transmitted back to the Authentication System 900 in response to a user gesture using that same phone rather than a web page. Security can be further enhanced by including a biometric voice print match using a spoken password.

### EXAMPLE EMBODIMENT 9

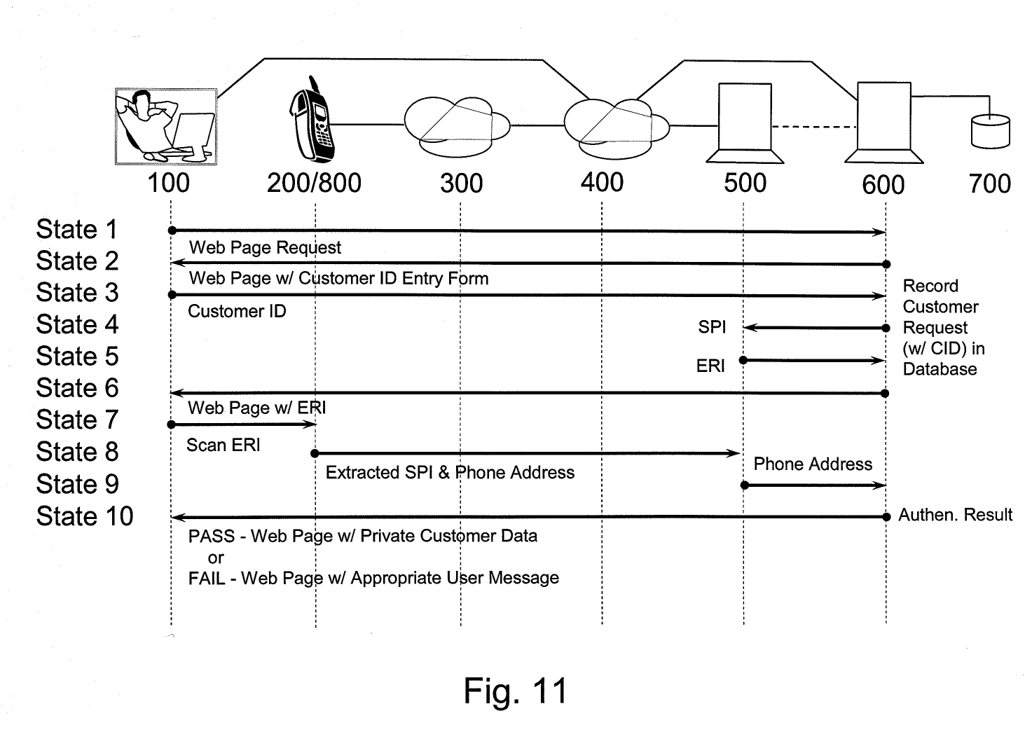

### See FIG. 11

FIG. 11 depicts a ninth example embodiment which adds a user step at the beginning of the process to enter account identification information (see FIGS. 12 and 13). This also eliminates the need to create, record and pass an SID.

State 1. The user accesses the bank's web site which hosts an online banking service by browsing to the bank's web site using, by example, a personal computer 100.

State 2. The bank's web hosting server 600 causes a New Registration & Login web page 2000 (see FIG. 12) to be displayed in response to the user request.

State 3. The user enters their unique customer identifier (CID) into the Customer ID Field 2300 and clicks the Login Button 2400.

State 4. The bank's web hosting server 600 looks up the CID in the user database 700 and records the login request event. The web hosting server 600 then forwards a request, along with the SPI for this service, to the phone server 500, requesting that an ERI image to be generated.

State 5. The phone server 500 receives the passed information from the bank's web hosting server 600 and creates an ERI for this user and service provider.

State 6. The bank's web hosting server 600 then merges the ERI onto the web page image and causes a new web page 3000 (see FIG. 13) to be displayed on the user terminal 100.

State 7. The user scans the ERI 3100 displayed on the web page 3000. In this example, the user uses his/her cell phone to perform the scanning operation.

State 8. The scanned ERI image is decoded by client software 800 within the mobile device 200 and the extracted information is routed to the banking service provider's phone server 500 using at least in part information included in the ERI. In the same transmission or a subsequent transmission, the wireless phone identifier of the mobile device is also transmitted to the phone server 500.

State 9. The phone server 500 transmits the extracted parameters to the web server 600.

State 10. The bank's web hosting server 600 compares the received phone identifier with, in this example, the list of active login requests from State 4. If the comparison results in a match, the web server 600 presents the user information to the user's web browser displayed on their terminal 100.

### EXAMPLE EMBODIMENT 10

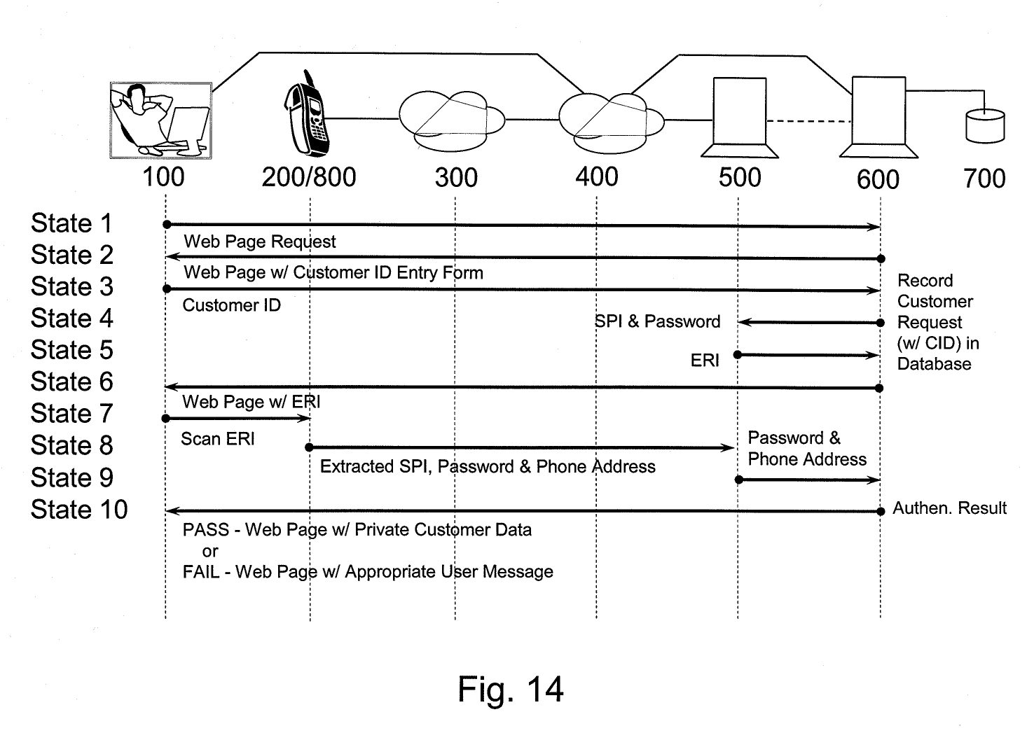

### See FIG. 14

FIG. 14 depicts a tenth example embodiment which strengthens the security of embodiment 9 by additionally passing the user's password recorded in the database 700 to the mobile phone 200 by encoding an encrypted copy in the ERI.

It should be understood that the herein examples listed only certain variations of the present invention and are not to be limited to only these variations. Other example variations are possible, e.g., the use of an account identifier together with a stored password in the mobile device of the user or the use of an account identifier together with a stored biometric.

In addition, it should be understood that certain variations and modifications of the systems and processes described herein would suggest themselves to one of ordinary skill in the art. The scope of the present invention is not to be limited by the illustrations or the foregoing descriptions thereof.

What is claimed is:

1. A method of authenticating a user over a network, comprising:
receiving over the network at an authentication system coupled to at least one network a login request from a user;
generating an electronic readable identifier which includes at least in part a first session identifier associated with the user login request;
causing at least in part the electronic readable identifier to be displayed on a terminal associated with the user;
determining a destination to transmit a phone identifier associated with the user and the first identifier to;
transmitting the first session identifier and the phone identifier to the destination;
receiving from a mobile device information obtained from the electronic readable identifier;
comparing the phone identifier with stored phone identifiers; and
enabling the user login associated with the first session identifier if the phone identifier corresponds to a stored phone identifier.

2. The method as defined in claim 1, wherein the destination for transmitting the phone identifier and the first session identifier is determined at least in part from information included in the electronic readable identifier.

3. The method as defined in claim 1, wherein the destination for transmitting the phone identifier and the first session identifier to is specified by the user.

4. The method as defined in claim 1, the method further comprising determining if the phone identifier and the first session identifier were received within a specified time period, and if not, the user login is not allowed.

5. The method as defined in claim 1, further comprising:
transmitting a first password to a terminal associated with the user;
at least partly causing a password entry field to be displayed on the terminal;
receiving a second password from the user; and
enabling the user login at least partly in response to determining that the first password corresponds to the second password.

6. A method of authenticating a user over a network, comprising:
receiving an indication that a user wants to login;
generating an electronic readable identifier which includes at least in part a first identifier associated with the user login indication;
causing at least in part the electronic readable identifier to be displayed on a terminal associated with the user;
receiving over the network the first identifier and a phone identifier of the user; and
enabling the user to login at least partly in response to a determination that the phone identifier corresponds to a stored phone identifier.

7. The method as defined in claim 6, wherein the first identifier is a session identifier associated with the user login indication.

8. The method as defined in claim 6, wherein a destination for routing the phone identifier and the first identifier is determined at least in part from information included in the electronic readable identifier.

9. The method as defined in claim 6, determining if the phone identifier and the first session identifier were received within a specified time period, and if not, the user login is inhibited.

10. The method as defined in claim 6, further comprising:
transmitting a first password to a user;
receiving a second password from the user; and
enabling the user login at least partly in response to a determination that the first password corresponds to the second password.

11. The method as defined in claim 6, wherein the network includes the Internet, the public switched telephone network, the wireless voice network, the wireless data network, and/or a private data network.

12. The method as defined in claim 6, wherein the electronic readable identifier includes at least a data matrix and/or barcode.

13. A method of authenticating a user over a network, comprising:
receiving an indication that a user wants to login;
receiving a customer identifier;
generating an electronic readable identifier;
causing at least in part the electronic readable identifier to be displayed on a terminal associated with the user;
receiving over a network a phone identifier associated with the user; and
enabling the user login at least partly in response to a determination that the phone identifier corresponds to a stored phone identifier.

14. The method as defined in claim 13, wherein the act of enabling the user login is further conditioned on the successful comparison of the received customer identifier with a stored customer identifier.

15. A method of authenticating a user over a network, comprising:
storing a password in a computer readable medium;
receiving an indication of a login request from a user;
generating an electronic readable identifier which includes at least in part a first identifier associated with the user login indication;
at least partly enabling the display of the electronic readable identifier on a terminal associated with the user;
receiving over a network the first identifier, the password, and a phone identifier associated with the user; and
enabling the user login if the phone identifier corresponds to a stored phone identifier and if the password corresponds to a stored password.

16. The method as defined in claim 15, wherein the first identifier is a session identifier associated with the user login indication.

17. The method as defined in claim 15, wherein the password is a biometric of the user.

18. The method as defined in claim 15, further comprising:
receiving a biometric from the user;
enabling the user login if the received biometric corresponds to a previously stored biometric from the user.

19. The method as defined in claim 15, wherein the destination for routing the first identifier, the password, and the phone identifier is determined at least in part from information included in the electronic readable identifier.

20. The method as defined in claim 15, further comprising:
transmitting a second password to a user;
receiving a third password from the user; and
enabling the user login if the second password corresponds to the third password.

21. The method as defined in claim 15, wherein the password is stored in a mobile device associated with the user.
